(19) United States
(12) Patent Application Publication
(10) Pub. No.: US 2017/0270832 A1
(43) Pub. Date: Sep. 21, 2017

(54) BRAIN EXHIBIT OR MODEL, AND METHOD OF USING OR DEPLOYING SAME

(71) Applicant: Lauren Hill, Houston, TX (US)

(72) Inventor: Lauren Hill, Houston, TX (US)

(21) Appl. No.: 15/460,058

(22) Filed: Mar. 15, 2017

Related U.S. Application Data
(60) Provisional application No. 62/308,843, filed on Mar. 15, 2016.

(51) Int. Cl. G09B 23/32; G09B 23/30; G09B 9/00

(52) U.S. Cl. CPC G09B 23/32; G09B 9/00; G09B 23/30

(57) ABSTRACT

An inflatable exhibit of a brain may include an inflatable infrastructure that is a three-dimensional at least partial representation of the brain. A walk-through passageway may be defined, at least in part, by the inflatable infrastructure, and may extend through at least a portion of the inflatable infrastructure. One or more brain features may be attached to or formed integral with the inflatable infrastructure. Each brain feature may be a representation of a brain structure or section, a brain activity, a brain ailment or injury, or a treatment of a brain ailment or injury. Each brain feature may be a three dimensional representation of the brain feature, a colored representation of the brain feature, a lighted representation of the brain feature, an inflatable representation of the brain feature, or combinations thereof. The inflatable exhibit may be used in a method for providing educational information about the human brain.

### CROSS-REFERENCE TO RELATED APPLICATIONS

The present application claims the benefit of U.S. Provisional Patent Application Ser. No. 62/308,843, filed on Mar. 15, 2016 (pending), the entirety of which is incorporated herein by reference.

### FIELD

The present disclosure relates to exhibits or models of a human part or organ, and more specifically, the human brain. The present disclosure also relates to a method of deploying, manufacturing, and/or using such an exhibit or model for academic or educational purposes.

### BACKGROUND

### Overview of the Brain

The brain is the most complex part of the human body. This three-pound organ is the seat of intelligence, interpreter of the senses, initiator of body movement, and controller of behavior. Lying in its bony shell and washed by protective fluid, the brain is the source of all the qualities that define our humanity. The brain is the crown jewel of the human body.

For centuries, scientists and philosophers have been fascinated by the brain, but until recently they viewed the brain as nearly incomprehensible. Now, however, the brain is beginning to relinquish its secrets. Scientists have learned more about the brain in the last 10 years than in all previous centuries because of the accelerating pace of research in neurological and behavioral science and the development of new research techniques. As a result, Congress named the 1990s the Decade of the Brain.

### The Architecture of the Brain

The brain is like a committee of experts. All the parts of the brain work together, but each part has its own special properties. The brain can be divided into three basic units: the forebrain, the midbrain, and the hindbrain.

The hindbrain includes the upper part of the spinal cord, the brain stem, and a wrinkled ball of tissue called the cerebellum. The hindbrain controls the body's vital functions such as respiration and heart rate. The cerebellum coordinates movement and is involved in learned rote movements. When you play the piano or hit a tennis ball you are activating the cerebellum. The uppermost part of the brainstem is the midbrain, which controls some reflex actions and is part of the circuit involved in the control of eye movements and other voluntary movements. The forebrain is the largest and most highly developed part of the human brain: it consists primarily of the cerebrum and the structures hidden beneath it.

When people see pictures of the brain it is usually the cerebrum that they notice. The cerebrum sits at the topmost part of the brain and is the source of intellectual activities. It holds your memories, allows you to plan, enables you to imagine and think. It allows you to recognize friends, read books, and play games.

The cerebrum is split into two halves (hemispheres) by a deep fissure. Despite the split, the two cerebral hemispheres communicate with each other through a thick tract of nerve fibers that lies at the base of this fissure. Although the two hemispheres seem to be mirror images of each other, they are different. For instance, the ability to form words seems to lie primarily in the left hemisphere, while the right hemisphere seems to control many abstract reasoning skills.

For some as-yet-unknown reason, nearly all of the signals from the brain to the body and vice-versa cross over on their way to and from the brain. This means that the right cerebral hemisphere primarily controls the left side of the body and the left hemisphere primarily controls the right side. When one side of the brain is damaged, the opposite side of the body is affected. For example, a stroke in the right hemisphere of the brain can leave the left arm and leg paralyzed.

### The Geography of Thought

Each cerebral hemisphere can be divided into sections, or lobes, each of which specializes in different functions. To understand each lobe and its specialty we will take a tour of the cerebral hemispheres, starting with the two frontal lobes, which lie directly behind the forehead. When you plan a schedule, imagine the future, or use reasoned arguments, these two lobes do much of the work. One of the ways the frontal lobes seem to do these things is by acting as short-term storage sites, allowing one idea to be kept in mind while other ideas are considered. In the rearmost portion of each frontal lobe is a motor area, which helps control voluntary movement. A nearby place on the left frontal lobe called Broca's area allows thoughts to be transformed into words.

When you enjoy a good meal—the taste, aroma, and texture of the food—two sections behind the frontal lobes called the parietal lobes are at work. The forward parts of these lobes, just behind the motor areas, are the primary sensory areas. These areas receive information about temperature, taste, touch, and movement from the rest of the body. Reading and arithmetic are also functions in the repertoire of each parietal lobe.

As you look at the words and pictures on this page, two areas at the back of the brain are at work. These lobes, called the occipital lobes, process images from the eyes and link that information with images stored in memory. Damage to the occipital lobes can cause blindness.

The last lobes on our tour of the cerebral hemispheres are the temporal lobes, which lie in front of the visual areas and nest under the parietal and frontal lobes. Whether you appreciate symphonies or rock music, your brain responds through the activity of these lobes. At the top of each temporal lobe is an area responsible for receiving information from the ears. The underside of each temporal lobe plays a crucial role in forming and retrieving memories, including those associated with music. Other parts of this lobe seem to integrate memories and sensations of taste, sound, sight, and touch.

### The Cerebral Cortex

Coating the surface of the cerebrum and the cerebellum is a vital layer of tissue the thickness of a stack of two or three dimes. It is called the cortex, from the Latin word for bark. Most of the actual information processing in the brain takes place in the cerebral cortex. When people talk about “gray matter” in the brain they are talking about this thin rind. The cortex is gray because nerves in this area lack the insulation that makes most other parts of the brain appear to be white. The folds in the brain add to its surface area and therefore increase the amount of gray matter and the quantity of information that can be processed.

### The Inner Brain

Deep within the brain, hidden from view, lie structures that are the gatekeepers between the spinal cord and the cerebral hemispheres. These structures not only determine our emotional state, they also modify our perceptions and responses depending on that state, and allow us to initiate movements that you make without thinking about them. Like the lobes in the cerebral hemispheres, the structures described below come in pairs: each is duplicated in the opposite half of the brain.

The hypothalamus, about the size of a pearl, directs a multitude of important functions. It wakes you up in the morning, and gets the adrenaline flowing during a test or job interview. The hypothalamus is also an important emotional center, controlling the molecules that make you feel exhilarated, angry, or unhappy. Near the hypothalamus lies the thalamus, a major clearinghouse for information going to and from the spinal cord and the cerebrum.

An arching tract of nerve cells leads from the hypothalamus and the thalamus to the hippocampus. This tiny nub acts as a memory indexer—sending memories out to the appropriate part of the cerebral hemisphere for long-term storage and retrieving them when necessary. The basal ganglia (not shown) are clusters of nerve cells surrounding the thalamus. They are responsible for initiating and integrating movements. Parkinson's disease, which results in tremors, rigidity, and a stiff, shuffling walk, is a disease of nerve cells that lead into the basal ganglia.

### Making Connections

The brain and the rest of the nervous system are composed of many different types of cells, but the primary functional unit is a cell called the neuron. All sensations, movements, thoughts, memories, and feelings are the result of signals that pass through neurons. Neurons consist of three parts. The cell body contains the nucleus, where most of the molecules that the neuron needs to survive and function are manufactured. Dendrites extend out from the cell body like the branches of a tree and receive messages from other nerve cells. Signals then pass from the dendrites through the cell body and may travel away from the cell body down an axon to another neuron, a muscle cell, or cells in some other organ. The neuron is usually surrounded by many support cells. Some types of cells wrap around the axon to form an insulating sheath. This sheath can include a fatty molecule called myelin, which provides insulation for the axon and helps nerve signals travel faster and farther. Axons may be very short, such as those that carry signals from one cell in the cortex to another cell less than a hair's width away. Or axons may be very long, such as those that carry messages from the brain all the way down the spinal cord.

Scientists have learned a great deal about neurons by studying the synapse—the place where a signal passes from the neuron to another cell. When the signal reaches the end of the axon it stimulates tiny sacs. These sacs release chemicals known as neurotransmitters into the synapse. The neurotransmitters cross the synapse and attach to receptors on the neighboring cell. These receptors can change the properties of the receiving cell. If the receiving cell is also a neuron, the signal can continue the transmission to the next cell.

### Some Key Neurotransmitters at Work

Acetylcholine is called an excitatory neurotransmitter because it generally makes cells more interactive le. It governs muscle contractions and causes glands to secrete hormones. Alzheimer's disease, which initially affects memory formation, is associated with a shortage of acetylcholine.

GABA (gamma-aminobutyric acid) is called an inhibitory neurotransmitter because it tends to make cells less excitable. It helps control muscle activity and is an important part of the visual system. Drugs that increase GABA levels in the brain are used to treat epileptic seizures and tremors in patients with Huntington's disease.

Serotonin is an inhibitory neurotransmitter that constricts blood vessels and brings on sleep. It is also involved in temperature regulation. Dopamine is an inhibitory neurotransmitter involved in mood and the control of complex movements. The loss of dopamine activity in some portions of the brain leads to the muscular rigidity of Parkinson's disease. Many medications used to treat behavioral disorders work by modifying the action of dopamine in the brain.

### Brain Disorders

When the brain is healthy it functions quickly and automatically. But when problems occur, the results can be devastating. Some 50 million people in this country—one in five—suffer from damage to the nervous system. Some of the major types of disorders include: neurogenetic diseases (such as Huntington's disease and muscular dystrophy), developmental disorders (such as cerebral palsy), degenerative diseases of adult life (such as Parkinson's disease and Alzheimer's disease), metabolic diseases (such as Gaucher's disease), cerebrovascular diseases (such as stroke and vascular dementia), trauma (such as spinal cord and head injury), convulsive disorders (such as epilepsy), infectious diseases (such as AIDS dementia), and brain tumors.

### Treatments

Neurosurgery—Neurosurgery is surgery on the brain. Neurosurgeons perform different procedures to cure or mitigate symptoms. Many tumors of the brain can be treated surgically. Also hydrocephalus, an abnormal accumulation of cerebrospinal fluid (CSF) in the ventricles, or cavities, of the brain, is often treated surgically.

Radiation—Gamma-knife radiosurgery treats a variety of structural abnormalities inside the brain by applying intersecting beams of radiation to the abnormal area. Gamma-knife radiosurgery is often a safer option than traditional neurosurgery because no incisions are involved.

In gamma-knife radiosurgery, doctors use advanced imaging technology to localize tumors and vascular abnormalities in the brain with pinpoint accuracy, so an array of radiation beams can be focused precisely on the target from many different directions.

Each individual radiation beam is too weak to harm the brain tissue it passes through. The effect of gamma-knife radiosurgery occurs only at the spot in the brain where all the beams meet. With the help of a computer, this spot can be accurately plotted to within a fraction of a millimeter.

Drugs—Many brain disorders are treated with drugs. There are a variety of drugs used to treat almost all types of brain disorders, including AIDs, Alzheimer's Disease,

Parkinson's Disease, epilepsy, stroke, brain cancer, and many others.

### The Problem

Many forms of brain problems may be preventable by diet, exercise, and other methods. Also, there are a number of methods to treat brain disease including drugs, exercise, surgery, and radiation. But brain problems and their prevention and treatment are complicated. There is a real need to educate the public about the types and causes of brain problems and the methods for prevention and medical treatments. This is especially true for younger people, as it is now known that some types of brain problems start with choices made early in life.

One method to help teach people about brain problems is to use a physical or computer model of the brains. There are numerous life-size physical models, computer-generated animations, cadaver brains, and other approaches used to help convey information about brain problems. But these often fail to effectively convey key understanding of the features of the brains because it is difficult so see and comprehend the small and complex brain anatomy. And many of these approaches are not particularly engaging.

One of the most effective methods to teach people about organ function and problems is to use an engaging, interactive, larger-than-life physical model so that the visitor can see the features of the organ up close. For example, The Smithsonian Institute in Washington D.C. developed a large exhibit on the human brain titled “Brain: The World Inside Your Head.” (see Reference 2). This large exhibit consists of a series of larger-than-life interactive displays illustrating various features of the brain. Visitors walk to the various displays to learn about the brain. However, they do not walk through a model of the brain itself. Also, this exhibit is very large, occupying more than 5000 square feet of floor space, and, consequently, is not easy to move.

The exhibit according to the present disclosure devises a method to allow visitors to see the structure and function of the brain using a pathway inside the brain exhibit that does not exist in the real brain.

### SUMMARY

In one aspect, the present disclosure is directed to providing (educational) information about or on the human brain using a large-scale, interactive, but portable model of the brain. The exhibit includes a walk-through path and cave areas where visitors can literally walk inside the tissue of the brain to see the interior structure and function. Having the exhibit larger-than-life facilitates seeing the detailed anatomy of the brain. And having the exhibit easily portable should enable more people to experience the exhibit by bringing the exhibit to where people might gather, for example at health fairs or community events. The idea is to make it more convenient for people to tour such an exhibit by essentially bringing the exhibit to them.

Certain embodiments of the present disclosure relate to an inflatable exhibit of a brain including an inflatable infrastructure that is a three-dimensional at least partial representation of the brain. A walk-through passageway may be defined, at least in part, by the inflatable infrastructure, and may extend through at least a portion of the inflatable infrastructure. One or more brain features may be attached to or formed integral with the inflatable infrastructure. Each brain feature may be a representation of a brain structure or section, a brain activity, a brain ailment or injury, or a treatment of a brain ailment or injury. Each brain feature may be a three dimensional representation of the brain feature, a colored representation of the brain feature, a lighted representation of the brain feature, an inflatable representation of the brain feature, or combinations thereof.

Certain embodiments of the present disclosure relate to a method for providing educational information about the human brain. The method may include providing an inflatable exhibit in accordance any of the embodiments disclosed herein. Users may walk around and through the inflatable exhibit, and may observe, read, and/or interact with the brain features of the inflatable exhibit.

As it relates to the present disclosure, the term “large-scale” refers to a positive ratio of the size of the brain in the exhibit to the size of a normal brain. Preferably, this ratio is greater than 10:1, but more preferably greater than 15:1 or 20:1. Also preferred is such a ratio that is less than 65:1, more preferably less than 60:1 or 50:1, and most preferably less than about 40:1 or 35:1. Thus, in some preferred embodiments, this ratio is between 10:1-15:1 and 25:1-40:1, or more preferably, between 20:1 and 35:1, and sometimes, between 20:1 and 30:1. Generally, the proportions (components\arts of the brain, height to length and other dimensions) provided or presented on the exhibit is close to anatomically correct, except that certain objects of presentations may be made relatively larger (than other parts or specific environment) to highlight that area or region of the brain, or a condition or environment on or about the brain (e.g. . . . , diseases, damage, or abnormal conditions, or a foreign implement such as a stent or blood clot retrieval, as described below).

The exhibit may include, present or highlight parts or regions of the brain, or conditions, including damage, abnormalities, treatment, or disease presentation). The exhibit may also present or include foreign implements such as the stent or blood clot retrieval device mentioned above. In further embodiments or applications, lighting features are used to dynamically present or exhibit chemical transfers. See. e.g., discussion of lighting features to present dopamine transfer (or other chemical transfer processes).

### BRIEF DESCRIPTION OF THE DRAWINGS

So that the manner in which the features and advantages of embodiments of the present disclosure may be understood in more detail, a more particular description of the briefly summarized embodiments above may be had by reference to the embodiments which are illustrated in the appended drawings that form a part of this specification. It is to be noted, however, that the drawings illustrate only various exemplary embodiments, and are therefore not to be considered limiting of the scope of this disclosure, as it may include other effective embodiments as well.

FIG. 1 is a schematic view of the front of one embodiment of the inflatable brain exhibit showing the entrance to the exhibit and the scale of exhibit in comparison to a person;

FIG. 2 is a cross-sectional view of one embodiment of the inflatable brain exhibit showing the walk-through pathway and cavity where some of the detailed features of the brain are shown;

FIG. 3 is a schematic view of the interior right wall of the inflatable brain exhibit that illustrates some of the internal structures of the brain;

FIG. 4 is a three-dimensional schematic view of the inflatable brain exhibit showing the cerebellum and brain stem at the rear of the inflatable brain exhibit;

FIG. 5 is a schematic view of an alternative configuration for the inflatable brain exhibit where the protective skull bone is visible above the right side of the brain;

FIG. 6 is a schematic cross-sectional view of the alternative brain model showing the walk-through pathway and cavities for illustrating further information about the brain;

FIG. 7 is a three-dimensional schematic view of the alternative inflatable brain exhibit showing the cerebellum and brain stem at the rear of the inflatable brain exhibit;

FIG. 8 is an illustrations of the inflatable brain exhibit having brain features thereon in accordance with certain embodiments of the present disclosure;

FIG. 9 is a simplified illustration of a brain exhibit feature representing myelineated and non-myelineated neurons along an upright wall or ceiling of a walk-through inflatable brain exhibit according to the present disclosure;

FIGS. 10A-10D are simplified illustrations of a brain feature of the inflatable brain exhibit including a series of light emitting devices, the action and\or positioning of which visually represents the electrical-to-chemical transmission mechanism between neurons, according to the present disclosure;

FIG. 11 is a simplified illustration of a brain feature of the inflatable brain exhibit visually representing the release of dopamine by a neuron, according to the present disclosure;

FIG. 12 is a simplified illustration of a brain feature of the inflatable brain exhibit visually representing differences in plasticity in the brain, according to the present disclosure;

FIG. 13 is a detailed illustration of mechanical thrombectomy device, for which a physical representation is mounted on the outer surface of the inflatable brain exhibit, according to the present disclosure; and

FIG. 14 is an illustration of the effects and treatment of an ischemic stroke event, for which a physical presentation 200z may be provided on the outer surface of the inflatable brain exhibit according to the present disclosure;

FIG. 15 depicts transmitting neuron, receptor cell, and dopamine activity in a normal, healthy patient, and transmitting neuron, receptor cell, and dopamine activity in a patient having Parkinson's disease; and

FIG. 16A-16D is a depiction of an exemplary, large-scale exhibit (preferably inflatable) of a human brain, with a one-story central walk-through passageway.

### DETAILED DESCRIPTION

Embodiments of the present disclosure will now be described more fully with reference to the accompanying drawings, which illustrate various exemplary embodiments. The disclosed concepts may, however, be embodied in many different forms and should not be construed as being limited by the illustrated embodiments set forth herein. Rather, these embodiments are provided so that this disclosure will be thorough as well as complete and will fully convey the scope to those skilled in the art and the best and preferred modes of practicing the embodiments. For example, many of the exemplary descriptions provided herein are concerned with an inflatable human brain. Aspects of the disclosure described may, however, be equally applicable to designs for and the manufacture of non-human brains, or other organs.

Certain embodiments of the present disclosure relate to an inflatable exhibit of a brain, a method of use of the inflatable exhibit to provide educational information regarding the brain, and to a method of making the inflatable exhibit.

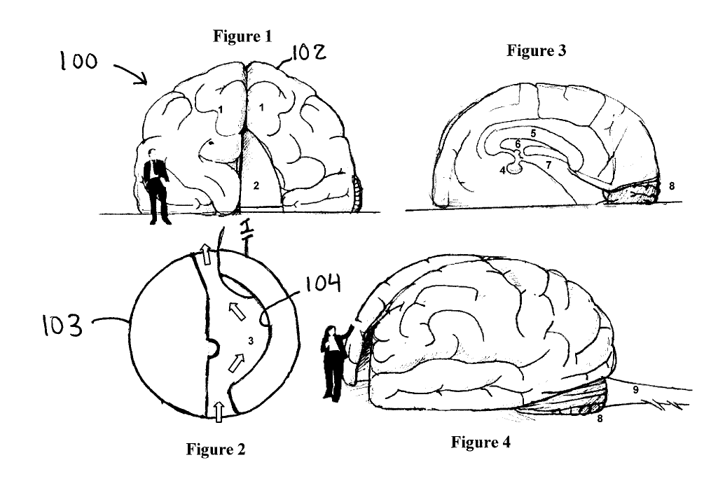

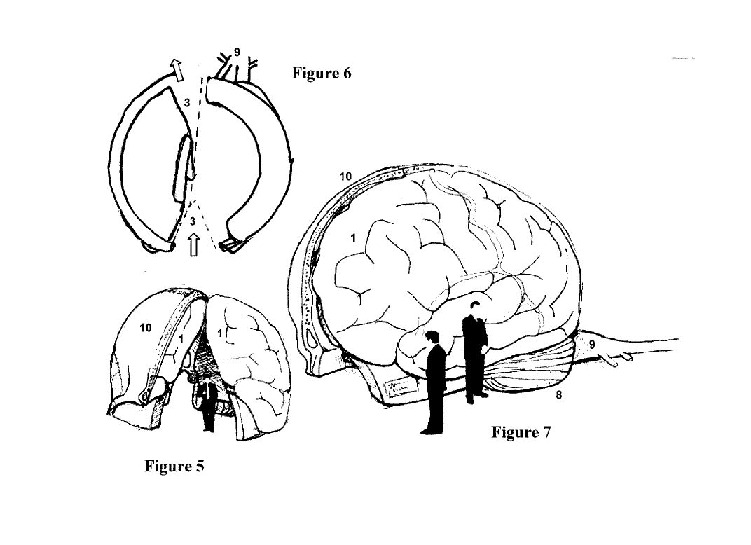

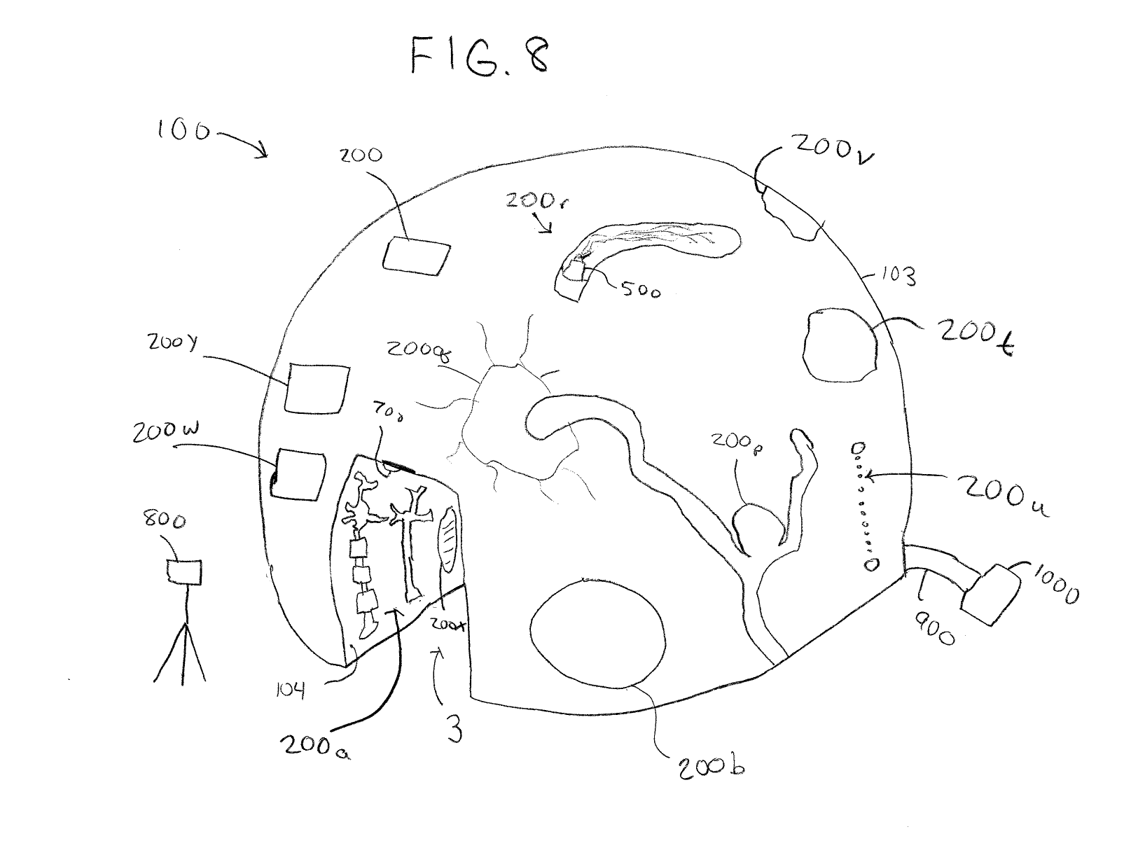

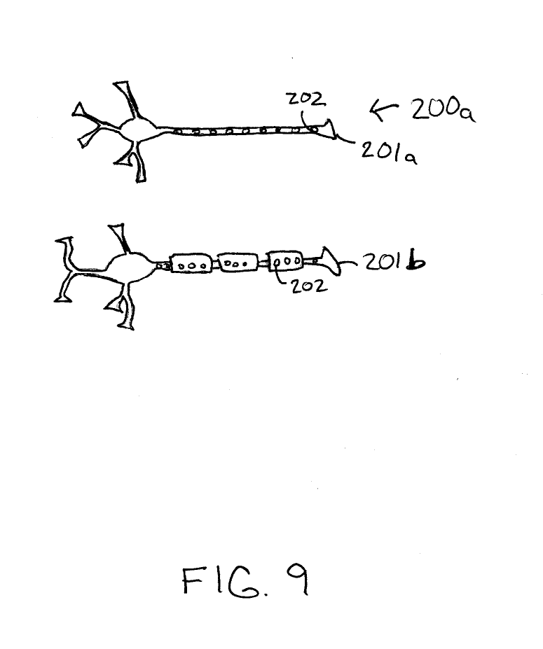

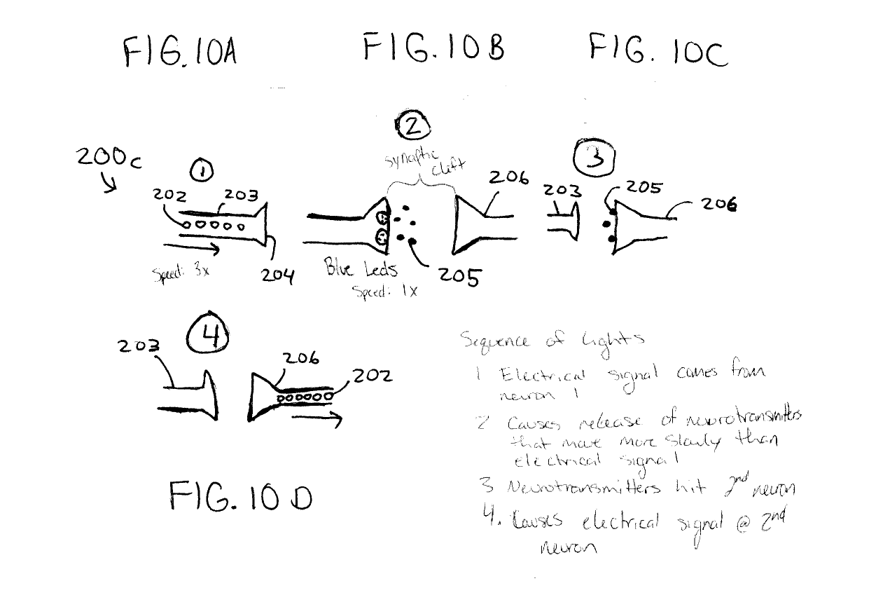

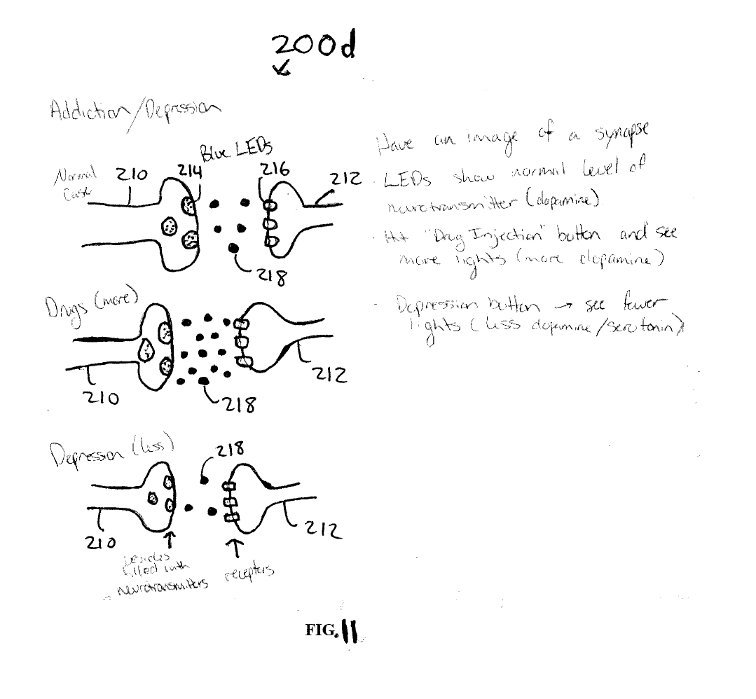

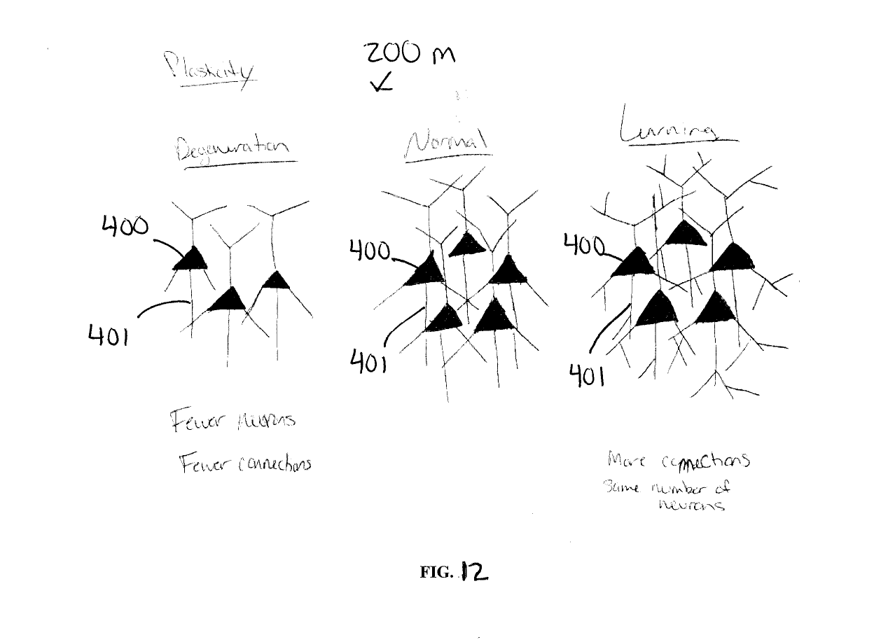

FIG. 1 depicts an embodiment of inflatable exhibit 100, here shown as a large-scale exhibit of the human brain that is equipped with one or more walk-in chambers. Portability of inflatable exhibit 100 may be achieved by fabricating inflatable exhibit 100 out of very lightweight materials. For example, inflatable exhibit 100 may be made of a lightweight, low-permeability polymer (e.g., vinyl coated nylon) fabric in such a manner that inflatable exhibit 100 can be inflated using air. The brain of inflatable exhibit 100 may be oriented in a manner similar to the brains orientation in the human body. In some embodiments, a visitor approaching inflatable exhibit 100 from the front, as shown in FIG. 1, would see cerebrum 1 and entrance 2 to the inside of inflatable exhibit 100. After entering the interior of inflatable exhibit 100, a visitor could walk along a walk-through pathway, defined by cavity 3, that passes inside inflatable exhibit 100 to the rear where the visitor could exit as illustrated in FIG. 2. On the inside of inflatable exhibit 100, the visitor could observe features of the brain on or attached to a near-vertical wall and on the curved wall of cavity 3 built into inflatable exhibit 100. The interior surfaces the inflatable exhibit 100 may illustrate various features of the brain, including pituitary gland 4, corpus callosum 5, hypothalamus 6 and pons 7. Cerebellum 8 may be visible at the rear of inflatable exhibit 100, as shown in FIG. 3. Brain stem 9 may also be visible at the rear of inflatable exhibit 100. As shown in FIG. 4, brain stem 9 may be swept toward one side to facilitate exiting inflatable exhibit 100. Inflatable exhibit 100 may be designed in such a manner that a visitor can walk inside inflatable exhibit 100 and observe small-scale structures of the brain, such as nerves and synapses, in their approximate location in the brain instead of on an abstract computer screen or other types of models.

In some embodiments, as shown in FIG. 5, inflatable exhibit 100 may include part of skull 10, here shown covering the right half of the brain to help illustrate how pressure can build up on the brain as a result of some types of injuries. FIG. 6 shows how alternative arrangements of the cavity 3 may be used to illustrate the interior features of the brain. FIG. 7 is a three-dimensional schematic of an alternative model showing skull 10, cerebellum 8, and brain stem 9.

Various features and diseases of the brain may be illustrated using larger-than-life three-dimensional structures in or on inflatable exhibit 100. Educational information about brain function, disease, treatment, and prevention may also conveyed using signage and illustrations both inside and outside inflatable exhibit 100. Some of the diseases depicted may include stroke, Alzheimer's disease, Parkinson's disease, brain trauma, and brain cancer. As such, a visitor may walk into one or more cavities 3 built into inflatable exhibit 100 to learn about the detailed structure and function of healthy and diseased brains.

In some embodiments, inflatable exhibit 100 is portable. In some embodiments, the brain of inflatable exhibit 100 is at least ten times larger than a life size brain. Inflatable exhibit 100 may weigh less than 250 pounds. In certain embodiments, inflatable exhibit 100 may be stored in a volume that is less than 75 cubic feet.

With further reference to FIGS. 1-7, inflatable exhibit 100 may include inflatable infrastructure 102 that is a three-dimensional at least partial representation of the brain. Inflatable infrastructure 102 may have exterior walls 103.

Walk-through passageway 3 (i.e., cavity) may be defined, at least in part, by inflatable infrastructure 102, and may extend through inflatable infrastructure 102. Walk-through passageway 3 may have interior walls 104.

Inflatable exhibit 100 may include one or more brain features attached to or formed integral with inflatable infrastructure 102. Each brain feature may be a representation of a brain structure, a brain activity, a brain ailment, or a treatment of a brain ailment, for example. Further, each brain feature may be a three dimensional representation of the brain feature, a colored representation of the brain feature, a lighted representation of the brain feature, an inflatable representation of the brain feature, or combinations thereof. The brain features may be physical and/or visually-oriented representations mounted on various display surfaces of inflatable exhibit 100, including along the walls, ceilings, and/or floor of walk-through passage 3 and along exterior wall 103 (i.e., the outer surface of inflatable exhibit 100.

For example and without limitation, FIG. 8 depicts brain feature 200a within walk-through passage 3 and brain feature 200b on exterior wall 103. Brain feature 200a shows a myelinated neuron and a non-myelinated neuron. Brian feature 200b is representative of a concussion. Brian feature 200b may be colored red, for example, to represent the damage caused to the brain by a concussion. As shown in FIG. 8, inflatable brain may include brain feature 200.

FIG. 9 is a detail view of brain feature 200a. Brian feature 200a may include two lines or series of neuron representations 201a and 201by, which may be presented across the ceiling or wall of walk-through passage 3. Neuron 201a is non-myelinated (un-myelinated) and Neuron 201b is myelinated. Myelin is produced by oligodendrocytes. Myelin is a fatty lipid that surround axons to increase the insulation so less electrical signal is lost. There are small regions of axons that are not myelinated, called Nodes of Ranvier. This conformation allows for saltatory conductance (the electric signal “hops” from node to node because the insulation from the myelin). These regions are have a high density of ion channels to regenerate the signal. To illustrate in the brain exhibit, and with reference to FIG. 9, a trail of lights 202 (e.g., LED lights) may be arranged to “run” through each row of neuron (separately) showing how transmission is much faster down myelinated axons in comparison to non-myelinated axons. For example, such differences between transmission rates may be shown by differences in the speed of the light sequence “traveling” down the neurons. In the top or unmylineated illustration, 201a, illumination of yellow LEDs may be synchronized to demonstrate slow speed. In the bottom representation of a myelineated neuron, 201b, the synchronization of LEDs may demonstrate a speed that is 2-3 faster than that of 201a, for example. In certain embodiments, a chain of neurons are physically represented and extended through the entire inflatable exhibit 100. In further embodiments, brain feature 200a may be connected to a neuron electrical-to-chemical transmission visual exhibit feature described elsewhere herein. Brain feature 200a may also include one or more information panels providing education information about myelineated neurons and non-mylineated neurons.

FIGS. 10A-10C illustrate brain feature 200c, which may be displayed on one or more portions of inflatable exhibit 100. Brian feature 200c may be a representation of electrical-to-chemical transmission in a neuron. For example, as shown in FIG. 10A, a sequence of lights 202 (e.g., yellow LEDs) may be illuminated so as to “run” down axon 203. The yellow lights, representing electrical signal, reach axon terminals 204 and induce the release of neurotransmitters 205 (in the synaptic cleft region), which may be represented by blue LEDs, as shown in FIG. 10B. The blue LEDs may be configured to “run” at a slower rate than the yellow LEDs. The blue LEDs may then be used to represent travel to, and arrival at, the next neuron 206; thereby, stimulating the next neuron 206, which may be indicated via electrical signals/yellow LEDs 202. In further embodiments, brain feature 200c may include a zoomed-in display on or of the axon terminal to show vesicles that are ready to be released. The illustrated sequence is illustrated in FIGS. 10A-10D, and is summarized as follows: 1. Electrical signals comes from neuron 1; 2. The signals cause release of neurotransmitters that move more slowly than the electrical signal; 3. The Neurotransmitters hit the 2^{nd} neuron; and 4. Electrical signals are generated at 2^{nd} neuron (FIG. 10D).

With reference to FIG. 11, brain feature 200d may be displayed on one or more portions of inflatable exhibit 100. Brain feature 200d may represent the release of dopamine by neurons, as associated with addiction and/or depression. Brain feature 200d may provides a representation or image of a synapse. The top illustration in FIG. 11 shows a neuron 210 releasing a “normal” level of dopamine 218 from neurotransmitters 214 towards receptors 216 of neuron 212. The middle illustration in FIG. 11 shows a neuron 210 releasing a level of dopamine 218 from neurotransmitters 214 towards receptors 216 of neuron 212 for a brain addicted to a drug (e.g., narcotic). The bottom illustration in FIG. 11 shows a neuron 210 releasing a level of dopamine 218 from neurotransmitters 214 towards receptors 216 of neuron 212 for a brain of a person diagnosed as depressed. The exhibit may further include a user-activated control to initiate display of further responses. A push-button or touch screen may be provided to simulate the response to ingestion and abuse of drugs (e.g., increase in dopamine represented by more illumination). Another push button or further activation of a trigger may be used to simulate depression (e.g., decrease in dopamine, fewer illumination). In some embodiments, dopamine 218 may be LED lights.

In some embodiments, brain feature 200, illustrated in FIG. 8, may represent neuron parts by velcro\matching activity. For example, a diagram of a neuron may be provided, which allows for matching the name to the proper part of the cell. As illustrated and known by educators, dendrites gather information and the cell body makes the choice to send on the message so it can travel down the axon. Myelin helps the information travel faster and the axon terminals are where the information is sent to the next cell. Information is transmitted between cells via small chemicals called neurotransmitters. Information is transmitted down a cell via electrical impulse.

Brain feature 200e may be any brain feature and/or exhibit feature as described herein. For example and without limitation, brain feature 200 may be brain feature 200c, 200d, 200m, or 200s described herein, below. Also, Brain feature 200 may be any brain feature and/or exhibit described in U.S. Provisional Patent Application No. 62/308,843. For example and without limitation, brain feature 200 may be the brain exhibit shown and described in FIGS. 9, 13-21 and 23-25 of U.S. Provisional Patent Application No. 62/308,843.

In some embodiments, brain feature 200 may illustrate neurons, which have various different shapes and sizes. The shapes and sizes of a neuron may determine which other neurons it makes connections with and how far it can send information.

In some embodiments, brain feature 200 may be a homunculus map. The homunculus is a “map” of the body in the motor cortex that represents all the areas of the body. The homunculus map be painted on the outside of motor cortex or sensory cortex, for example. Certain body parts (like the fingers and face) get more brain space because they have more nerve endings and therefore send more information. Other regions like the back have smaller areas because they have fewer nerves. This map can be found in the spinal cord, up through the brain, and finally at the motor cortex.

In some embodiments, brain feature 200 may include visual indicators to indicate or outline the different lobes of the brain. This may be accomplished with the aid of text, colors, graphics, or voice activated recordings. To outline the lobes, thick, bold lines or possibly lights may be used. Descriptive illustrations or drawings may be employed to indicate or illustrate each lobe's responsibility responsibly. For example, an illustration of an eye may be found on the visual cortex, an illustration of an ear on the temporal lobe, an illustration of a thermometer or hot hand on the parietal lobe, and illustration associated with emotions or emoticons on the frontal lobe.

In some embodiments, brain feature 200 may be a feature representing microglia (flap). Microglia are the special immune cells in the brain. Usually they have a ramified structure (left image) and are constantly surveying the environment (neurons) around them. If there is an insult or injury to the brain, microglia change their function and shape to fight infections or damage. Such a brain feature 200 may be made more cartoon-like and whimsical, e.g., by drawing the normal, surveying microglia as smiling and the activated, fighting microglia as a hulk or a warrior or red and angry. A flap may be employed to show a normal, calm microglia evenly spaced out and ramified in a healthy brain. The flap may be lifted, however, to reveal the underside showing a sick or inflamed brain with lots of activated microglia close together. In some embodiments, brain feature 200i may be placed near the meningitis portion of the exhibit.

In some embodiments, brain feature 200 may be used to show other cell types in brain and how they work together. There are four main cell types in the brain: neurons, astrocytes, microglia, and oligodendrocytes. Astrocytes wrap around synapses and blood brain barrier. They remove toxins and extra neurotransmitters from the synapse and give energy (lactate) to the neurons. Oligodendrocytes are the cells that myelinate neurons. They make a fatty layer (myelin) that wraps around the neuron axons to speed up the flow of information. Microglia are the immune cells of the brain. They eat up dying cells and any toxins or pathogens that get into the brain. Usually they are calm and provide growth support for neurons but when there is an injury or infection, they shift to an inflammatory activity. They will secrete toxic cytokines to kill off the infection or pathogen and then eat a lot of tissue to get rid of the danger.

In some embodiments, brain feature 200 may be displayed on one or more portions of inflatable exhibit 100, and may be used to show the blood brain barrier. The blood brain barrier is what makes the brain an immune privileged organ. Various cell types, including astrocytes and endothelial cells, wrap around blood vessels to block large molecules and neurotoxins that could harm the brain. The blood brain barrier is, however, highly selectively permeable, allowing water, gases, and lipid-soluble molecules to cross over via passive diffusion. It also allows for the selective transport of molecules that are critical for brain health and energy, like glucose and amino acids. Such a brain feature 200 may be located near information about microglia (brain-specific immune cells) or provided as zoomed-in image on any vessels inside or outside of inflatable exhibit 100.

FIG. 12 illustrates brain feature 200m, which may be displayed on one or more portions of inflatable exhibit 100. Brain feature 200m shows the difference in plasticity and how learning works in the brain. Neurons are very plastic or easily changed. One mechanism of learning is by making more synaptic connections. In degenerative diseases like Alzheimer's, brains lose such connections and also whole neurons. Neurons are one of the few non-dividing cells in your body and cannot be easily replaced. This is partly why it is so hard to find a cure or treatment for neurodegenerative diseases. FIG. 12 provides three different illustrations showing the different plasticity conditions, including differences in the number of neurons and connections. On the left side of FIG. 12, neurons 400 and associated connections 401 in a brain in a degenerated state (e.g., a brain of a depressed person) are shown. On the right side of FIG. 12, neurons 400 and associated connections 401 in a brain in a learning state are shown. In the middle of FIG. 12, neurons 400 and associated connections 401 in a brain in a normal state are shown. In the degenerated state, the brain may include fewer neurons and/or fewer connections between neurons relative to the normal state. In the learning state, the brain may include more neurons and/or more connections between neurons relative to the normal state. In some embodiments, neurons 400 may be LED lights. Such LED lights may be configured to be selectively turned on and off to represent different plasticities.

With further reference to FIG. 8, inflatable exhibit 100 may include brain feature 200p, which may be displayed on one or more portions of inflatable exhibit 100. Brain feature 200p may display a representation of an aneurism. Brain feature 200p may be physically represented by a 3-D exhibit feature on exterior wall 103. Brian feature 200c may be an inflatable and deflectable feature, and may be configured to continuously and sequentially inflate and deflate, such as via use of a pump (e.g., an air pump).

Brain feature 200q may be displayed on one or more portions of inflatable exhibit 100. Brain feature 200q may be a representation of a stroke (e.g., a hemorrhage stroke).

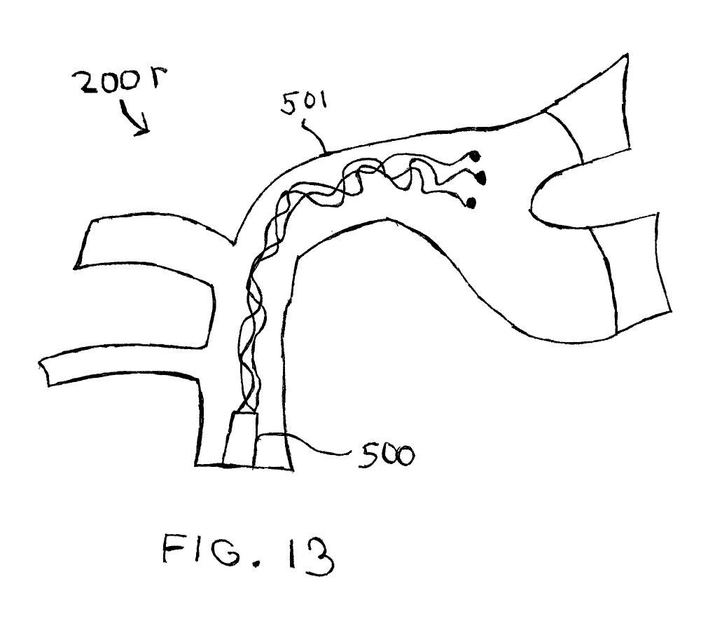

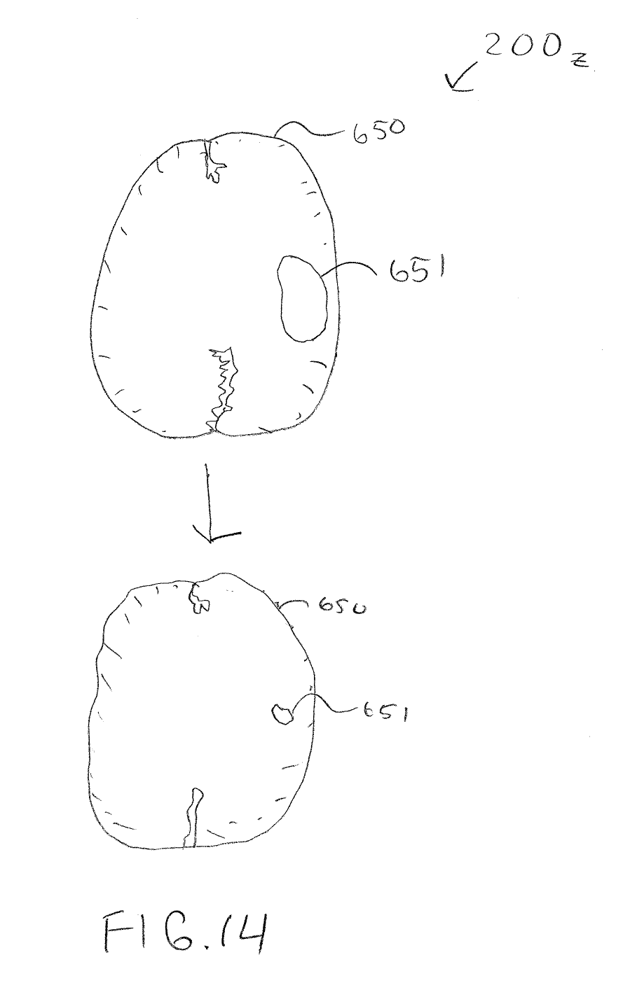

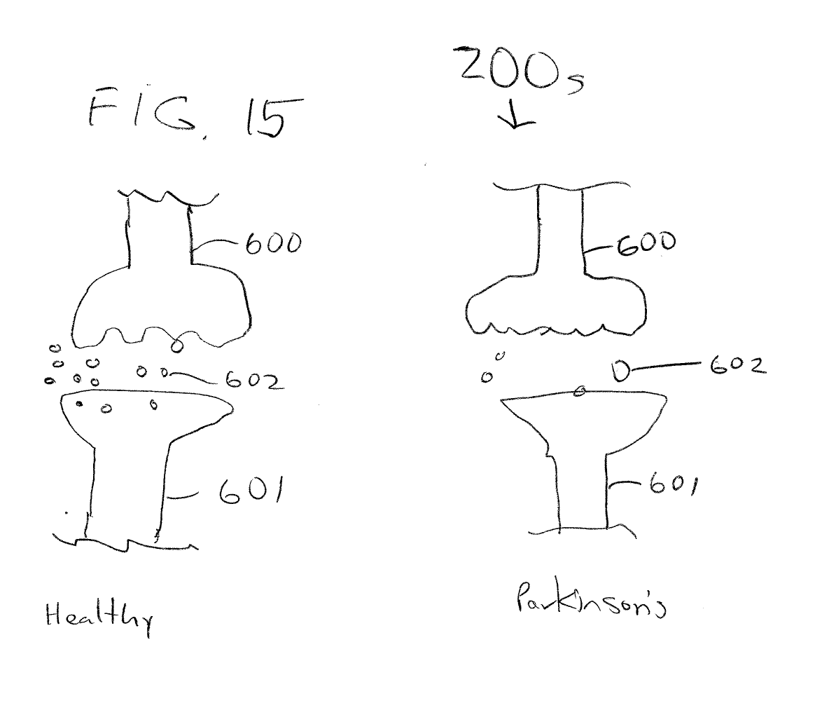

Brain feature 200r may be displayed on one or more portions of inflatable exhibit 100. Brain feature 200r may be a representation of a stroke treatment (e.g., a hemorrhage stroke). For example, brain feature 200r may display device 500 used to remove stroke causing clots, such as a SOLITAIRE 2™. FIG. 13 provides a detailed view of brain feature 200r in accordance with certain embodiments. Brain feature 200r may provide a representation of an implementation of interventional neuro radiology. While brain feature 200r is shown as located toward the top of the outside surface of the brain, brain feature 200r may be positioned elsewhere on inflatable exhibit 100. Interventional Neuro Radiology (INR) is a sub-specialty of radiology that utilizes minimally invasive image-guided procedures to diagnose and treat diseases in nearly every organ system. The SOLITAIRE 2™ is a mechanical thrombectomy device that combines the ability to restore blood flow, administer medical therapy, and retrieve clot in patients experiencing acute ischemic stroke. This device is used for patients with ischemic stroke due to intracranial vessel occlusion. Patients who may not be eligible for IV t-pa or who receive IV t-pa and require further treatment. FIG. 13 is a simplified illustration of brain feature 200r showing ischemic stroke treatment, with device 500 positioned within vein or artery 501. Specifically, the treatment being shown employs tissue plasminogen activator. Brain feature 200r may include two physical representations of the extent of ischemic injury as revealed on the outer surface of inflatable exhibit 100. Brain features 200p, 200q, and/or 200r may include models and/or information regarding strokes, aneurysms, and current treatment options. Such brain features my display and discuss, e.g., clot retrieval devices (stent inside an aneurysm), clot busting drugs (e.g., TPA), interventional neuroradiology, aneurysm treatment such as embolic coils and flow diverters, arteriovenous malformations, and deep brain stimulation therapies.

FIG. 14 is an illustration of the effects and treatment of an ischemic stroke event, for which a physical presentation 200z may be provided on the outer surface of the inflatable brain exhibit 100. Brain feature 200z may display a brain 650 that has experienced a stroke damage 651 (infarction penumbra), as well as a brain 650 after reperfusion, which may reduce the extend of ischemic injury 651.

FIG. 15 depicts brain feature 200s, which may be displayed on one or more portions of inflatable exhibit 100. Brain feature 200s shows transmitting neuron 600, receptor cell 601, and dopamine 602 activity. The dopamine 602 activity of a normal, healthy patient is shown on the left side of FIG. 15, and the dopamine 602 activity of a patient having Parkinson's disease is shown in the right side of FIG. 15. Such a display may use lights, such as LEDs, to visually represent the neurons and/or dopamine.

With further reference to FIG. 8, brain feature 200t may be displayed on one or more portions of inflatable exhibit 100. Brain feature 200t may represent a portion of the brain affected by Alzheimer's. Brain feature 200t may be colored gray, for example, to represent the affected portion of the brain.

Brain feature 200u may be displayed on one or more portions of inflatable exhibit 100. Bain feature 200u may represent electrical conduction in the brain. For example, brain feature 200u may be a string of lights, such as tracer and/or non-tracer LEDs, that are configured to light up in sequence. In embodiments, one or more of brain feature 200u may be used to indicate electrical conduction in the brain for a normal, healthy person, for an epileptic person, for a depressed person, for a drug addicted person, or the like.

Brain feature 200v may be displayed on one or more portions of inflatable exhibit 100. Bain feature 200v may represent brain trauma. For example, brain feature 200v may be red patch on the brain to represent the traumatized portion of the brain.

Brain feature 200w may be displayed on one or more portions of inflatable exhibit 100. Bain feature 200w may be an informational panel and/or screen, providing information regarding the brain, brain safety, brain injuries or ailments, brain treatments, or the like. In some embodiments, such informational panel and/or screen are provided for each brain feature on inflatable exhibit.

Brain feature 200x may be displayed on one or more portions of inflatable exhibit 100. Bain feature 200x may represent one or more portions of the limbic system.

Brain feature 200y may be displayed on one or more portions of inflatable exhibit 100, such as the portion of the brain associated with vision. Brain feature 200y may be a display screen (e.g., an iPAD®) showing an inverted image. For example, in operation, a video camera 800 may be used to show inverted vision in visual cortex. The video camera 800 may be set up to the front of the brain, such as where the eyes would be. The video camera 800 may be in data communication with the display screen of brain feature 200y, which may be located at the back of the brain where the visual cortex is. The image on the display screen of brain feature 200y may be inverted, as is processed by the brain. The display screen of brain feature 200y may display a stationary, inverted image of a city, for example. In some embodiments, such display screens and/or cameras may be integrated with or used with other brain features, such as brain features associated with the effect or condition of a brain concussion. For example, a “concussion button” or control may be provided that, when activated, initiates flashes on the screen. Such flashes may be bright for a time period, but may then become dark to simulate what happens during a concussion. Because the visual cortex is in the back of the brain, it is the most likely to get hit against the skull in most concussions, causing temporary vision problems. This makes the location of the vision screen for this exhibit feature to be an appropriate one, in some embodiments.

Inflatable exhibit 100 may include pump 1000, which may be in fluid communication with inflatable exhibit 100, such as via conduit 900, for providing air into an interior of inflatable exhibit 100 to maintain inflatable exhibit 100 in an inflated state.

In some embodiments, one or more lights 700, such as removable light-emitting diode lights, are used to illuminate the cavity 3. Such lights 700 may be attached to the cavity 3 using, for example, hook and loop fasteners (VELCRO®) or any other attachment method.

As described herein, the brain features may include representations of normal brain structures (e.g., neurons) and/or sections (e.g., lobes) and/or activity (e.g., dopamine activity); abnormal brain structures (e.g., strokes) and/or activity (ailments, injuries, and the like); information aids (e.g., information panels and/or screens); foreign structures (e.g., non-brain structures, such as a stent); or combinations thereof. As described herein, each brain feature may include a three dimensional representation of the brain feature, a colored representation of the brain feature, a lighted representation of the brain feature, an inflatable representation of the brain feature, or combinations thereof. Each brain feature disclosed herein may include one or more lighted elements to represent portions of the brain feature. For example lights may be turned on to represent active neurons (e.g., neurons that are firing), dopamine activity, plasticity, or any other portion of the brain exhibits disclosed herein.

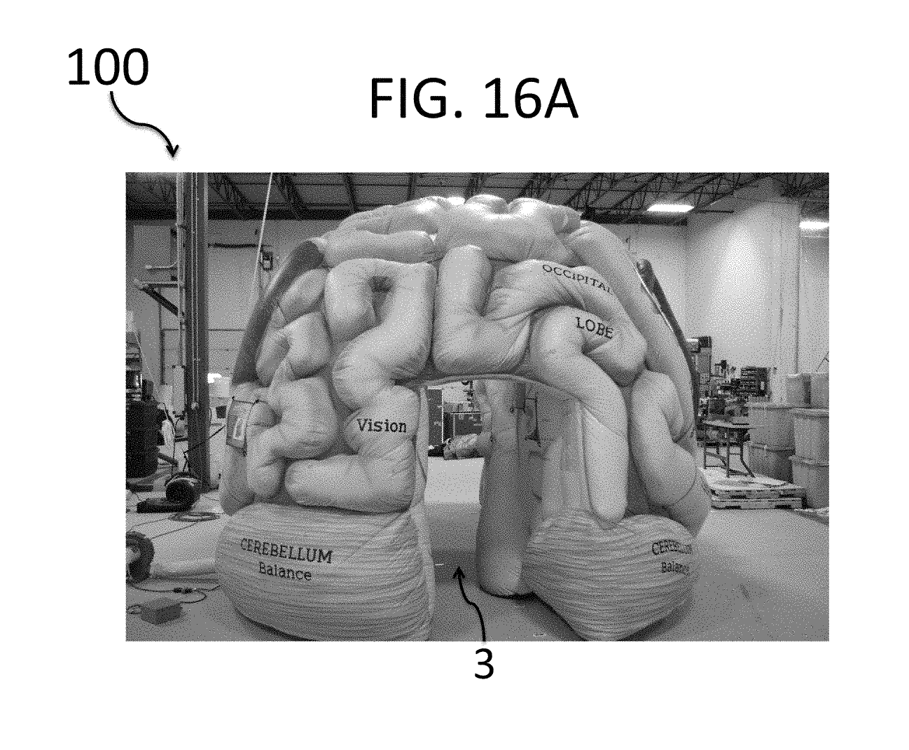

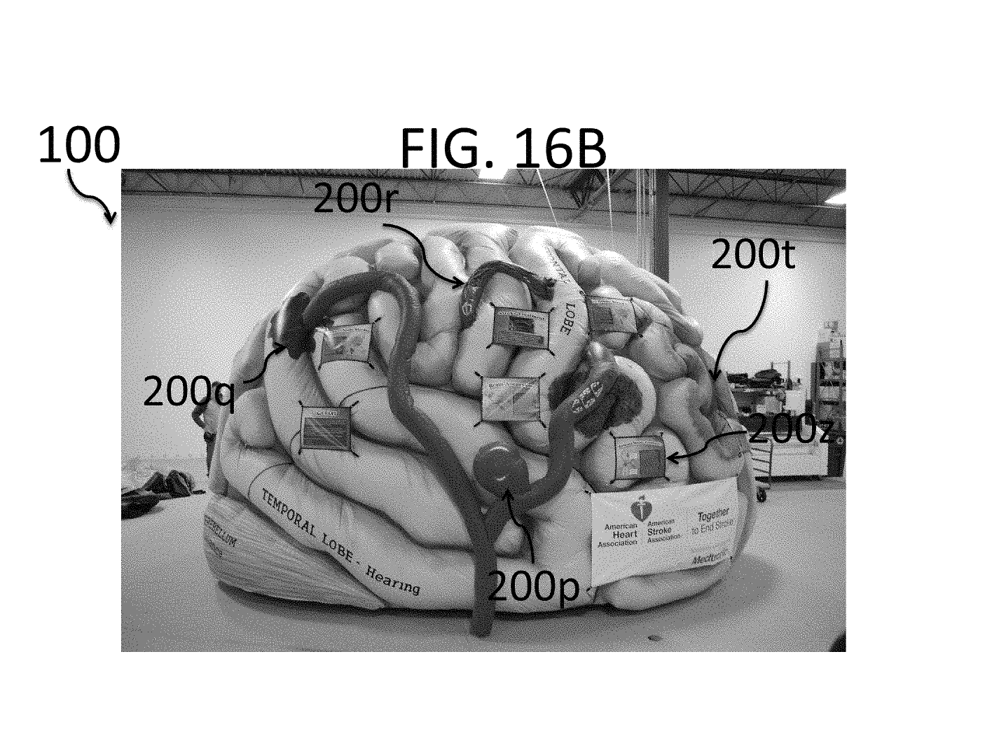

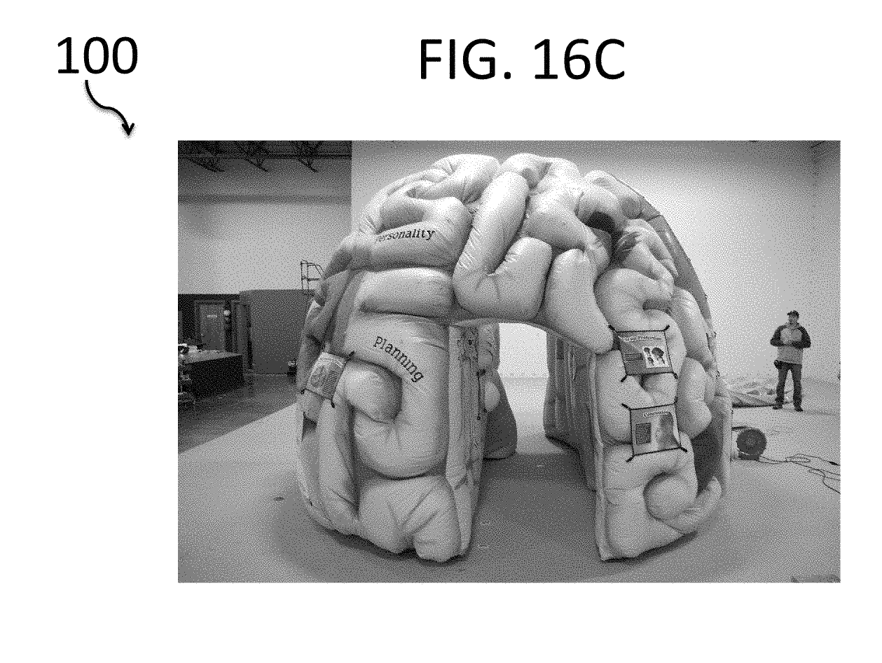

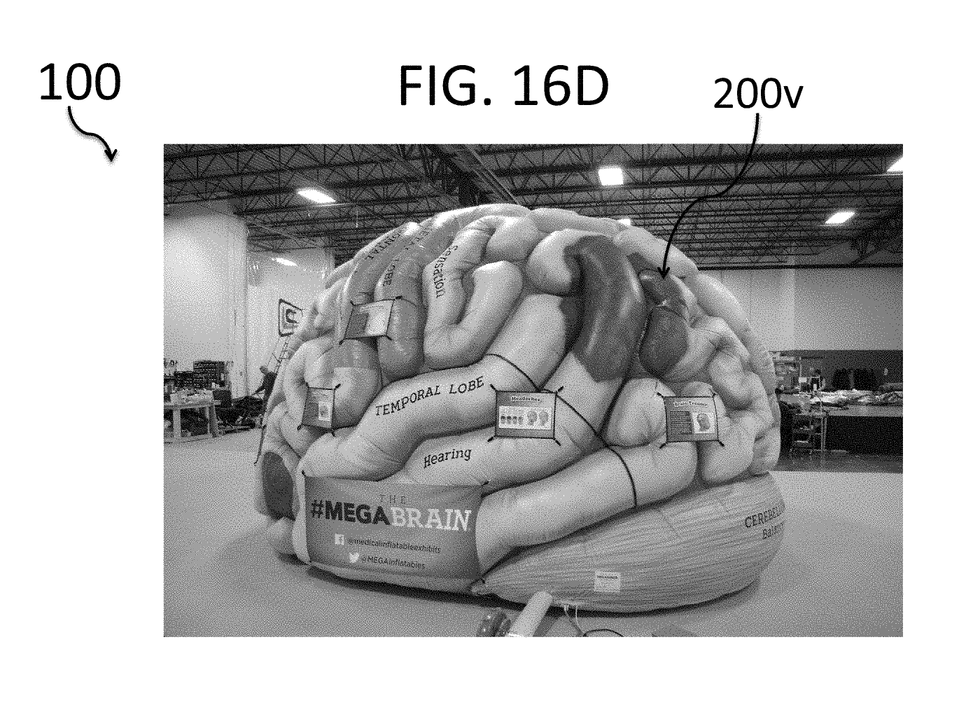

FIG. 16 is a depiction of an exemplary, large-scale exhibit 100 of a human brain. The exhibit is preferably made of inflatable materials and, when inflated, presents a one-story preferably, linear central walk-through passageway. The outer surface of the brain is equipped with informational plaques or exhibits, and larger scale representations of parts of the brain, provided to highlight certain conditions, abnormalities, and treatments to regions or parts of the brain. The outer surface is also equipped with presentations of foreign (i.e., foreign to the human anatomy) medical implements (e.g., blood clot retrieval device) as used or deployed on the brain. Specifically, FIG. 16A depicts a view of inflatable exhibit 100 showing cavity 3, the occipital lobe, the portion of the brain responsible for vision, and the section of the brain responsible for cerebellum balance. FIG. 16B depicts a view of inflatable exhibit 100 showing brain features 200r (stroke treatment), 200q (stroke), 200p (aneurysm), 200z (stroke treatment), and 200t (Alzheimer's) as detailed below. FIG. 16C depicts another view of inflatable exhibit 100 showing portions of the brain responsible for planning and personality. FIG. 16D depicts a view of inflatable exhibit 100 showing brain features 200v (trauma), as well as various sections of the brain, including the portion of the brain responsible for hearing and sensation, as well as the temporal lobe.

Although the presently disclosed product, system and\or process and their advantages have been described in detail, it should be understood that various changes, substitutions and alterations can be made herein without departing from the spirit and scope of the disclosure and as defined by the appended claims. Moreover, the scope of the present disclosure is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

1. An exhibit of a brain comprising:
an infrastructure that is a three-dimensional at least partial representation of the brain;
a walk-through passageway defined, at least in part, by the infrastructure, and extending through at least a portion of the infrastructure;
one or more brain features attached to or formed integral with the infrastructure;
wherein each brain feature is a representation of a brain structure or section, a brain activity, a brain ailment or injury, or a treatment of a brain ailment or injury; and
wherein each brain feature is a three dimensional representation of the brain feature, a colored representation of the brain feature, a lighted representation of the brain feature, an inflatable representation of the brain feature, or combinations thereof.

2. The exhibit of claim 1, wherein the one or more brain features are located on a surface of the infrastructure within the walk-through passageway, on a surface of the infrastructure outside of the walk-through passageway, or combinations thereof.

3. The exhibit of claim 1, wherein the one or more brain features comprise:
representations the pituitary gland, corpus callosum, hypothalamus, pons, cerebellum, brain stem, skull, or combinations thereof; or
a homunculus map; or
a representation of microglia, neurons, astrocytes, oligodendrocytes, or combinations thereof; or
a representation of the blood brain barrier; or
a representation of a portion of the brain affected by Alzheimer's, brain trauma, a concussion, or combinations thereof; or
a representation of one or more portions of the limbic system; or
visual indicators that indicate or outline different lobes of the brain; or
one or more informational panels and/or screens that provide information regarding the brain, brain safety, brain injuries or ailments, brain treatments, or combinations thereof.

4. The exhibit of claim 1, wherein the one or more brain features comprise a representation of myelinated and non-myelinated neurons comprising two trails of lights configured to show differences in transmission down myelinated axons in comparison to non-myelinated axons.

5. The exhibit of claim 1, wherein the one or more brain features comprise a representation of electrical-to-chemical transmission in a neuron comprising a sequence of lights.

6. The exhibit of claim 1, wherein the one or more brain features comprise a representation of dopamine release by neurons showing dopamine release for a normal brain, a drug addicted brain, a depressed brain, or combinations thereof.

7. The exhibit of claim 6, further comprising a push-button or touch screen to simulate the response to ingestion and abuse of drugs and/or to simulate depression in the brain.

8. The exhibit of claim 1, wherein the one or more brain features comprise a representation of neuron parts and a diagram of a neuron on the inflatable exhibit, wherein the representations of neuron parts are attachable to the diagram.

9. (canceled)

10. (canceled)

11. (canceled)

12. The exhibit of claim 1, wherein the one or more brain features comprise a representation of neurons of different plasticity in the brain, including neurons in a degenerated state, a normal state, an learning state, or combinations thereof, wherein the representation of neurons of different plasticity in the brain comprises lights that represent the neurons and pictorial representations of connections between neurons.

13. (canceled)

14. The exhibit of claim 1, wherein the one or more brain features comprise:
a representation of an aneurism, wherein the representation of the aneurism is an inflatable and deflectable brain feature configured to sequentially inflate and deflate;
a representation of an aneurism treatment comprising a foreign implementation; or combinations thereof.

15. The exhibit of claim 1, wherein the one or more brain features comprise a representation of a stroke, a representation of a stroke treatment comprising a foreign implementation, or combinations thereof.

16. (canceled)

17. The exhibit of claim 14, wherein the foreign implementation comprises a clot retrieval device or a clot busting drug.

18. (canceled)

19. The exhibit of claim 14, wherein the foreign implementation comprises a flow diverter or embolic coil.

20. The exhibit of claim 1, wherein the one or more brain features comprise a representation of a transmitting neuron, receptor cell, and dopamine activity, wherein lights visually represent the neurons and/or the dopamine.

21. (canceled)

22. (canceled)

23. The exhibit of claim 1, wherein the one or more brain features comprise a representation of electrical conduction in the brain comprising tracer and non-tracer LEDs configured to light up in sequence.

24. The exhibit of claim 23, wherein the representation of electrical conduction is configured to indicate electrical conduction in the brain for a normal, healthy person, for an epileptic person, for a depressed person, for a drug addicted person, or combinations thereof.

25. (canceled)

26. (canceled)

27. The exhibit of claim 1, wherein the one or more brain features comprise a display screen showing an inverted image representative of images processed by the brain in the visual cortex.

28. The exhibit of claim 1, wherein the infrastructure is an inflatable infrastructure that is inflatable to a three-dimensional partial representation of the brain at a scale greater than at least 15:1.

29. The exhibit of claim 1, wherein the one or more brain features comprise moveable elements that simulate brain function.

30. (canceled)

31. The exhibit of claim 1, wherein the one or more brain features comprise a synchronized illumination to illustrate neuron activity.

32. The exhibit of claim 1, wherein the infrastructure includes a profiled outer surface that physically represents the outer surface of the brain.

33. (canceled)

34. The exhibit of claim 1, wherein the one or more brain features comprise a representation of a brain that has experienced a stroke and a brain after reperfusion.

35. (canceled)

36. A method for providing educational information about the human brain, the method comprising providing an exhibit of a brain, the exhibit including:
an infrastructure that is a three-dimensional at least partial representation of the brain;
a walk-through passageway defined, at least in part, by the infrastructure, and extending through at least a portion of the infrastructure;
one or more brain features attached to or formed integral with the infrastructure;
wherein each brain feature is a representation of a brain structure or section, a brain activity, a brain ailment or injury, or a treatment of a brain ailment or injury; and
wherein each brain feature is a three dimensional representation of the brain feature, a colored representation of the brain feature, a lighted representation of the brain feature, an inflatable representation of the brain feature, or combinations thereof.

37. (canceled)
